(19) United States
(12) Patent Application Publication
(10) Pub. No.: US 2016/0207583 A1
(43) Pub. Date: Jul. 21, 2016

(54) BIKEBOARD

(71) Applicant: Conway Bikeboards LLC, Seattle, WA (US)

(72) Inventor: Darren Conway, Seattle, WA (US)

(21) Appl. No.: 14/996,523

(22) Filed: Jan. 15, 2016

Related U.S. Application Data
(60) Provisional application No. 62/106,099, filed on Jan. 21, 2015.

(51) Int. Cl. B62K 3/00; B62K 21/18

(52) U.S. Cl. CPC B62K 3/002; B62K 21/18

(57) ABSTRACT

The present invention is directed to a rideable and steerable “bikeboard” that combines aspects of bicycling and longboard-style skateboarding. In one embodiment, the bikeboard is a low-profile riding platform connected to a steerable front bicycle assembly with a modular frame. The riding platform may take the form of a longboard-style deck with removable front and rear wheel truck assemblies. The front bicycle assembly includes a large, front wheel, bicycle-style handlebars and a braking system.

### PRIORITY CLAIM

The present application claims the benefit of U.S. Provisional Patent Application No. 62/106,099 filed on Jan. 21, 2015, the contents of which are hereby incorporated by reference in its entirety.

### FIELD

The present invention is generally directed to a bikeboard, and more specifically to a bikeboard having a modular frame assembly.

### BACKGROUND

Bicycles and skateboards are traditionally two distinct human-powered, modes of transportation. Both may be used for recreational, competitive, leisure, or other purposes. There have been several attempts to combine these two types of transportation.

One known product is a skateboard-bike hybrid kick scooter made by Sbyke USA, IC, headquartered in Las Vegas, Nev., USA. The hybrid kick scooter features a special L-shaped frame that connects a handlebar assembly, a bicycle BMX type wheel and a small board or deck (hereinafter “deck”). Another known product is also a hybrid kick scooter made by the Mongoose BikeBoard Group having a unitary frame design that extends a length of the deck, which means the frame extends from the handlebar forks to the rear truck of the deck.

### BRIEF SUMMARY

In one aspect of the present invention, a modular frame assembly for a bikeboard having a front bicycle assembly and a deck assembly includes a frame body, an upper mounting plate, and a lower mounting plate. The frame body has a steering connector configured to be coupled to the front bicycle assembly. The upper mounting plate is coupled to the frame body. The upper mounting plate includes an upper plate bolt pattern arranged for attaching to an upper surface of a front portion of the deck assembly. The deck assembly includes a complementary deck bolt pattern. The lower mounting plate includes a lower plate bolt pattern arranged for attaching to a bottom surface of the deck assembly with the deck bolt pattern. The upper and lower mounting plates operate to sandwich a front portion of the deck assembly.

In another aspect of the present invention, a bikeboard includes a front bicycle assembly having a wheel, handlebars, and a braking system. A deck assembly includes a riding platform coupled to a rear truck, which is coupled to skateboard wheels. A frame body has a steering connector configured to be coupled to the front bicycle assembly. An upper mounting plate is coupled to the frame body, the upper mounting plate having an upper plate bolt pattern arranged for attaching to an upper surface of a front portion of the deck assembly. The deck assembly includes a complementary deck bolt pattern. A lower mounting plate has a lower plate bolt pattern arranged for attaching to a bottom surface of the deck assembly with the deck bolt pattern. The upper and lower mounting plates operate to sandwich the front portion of the deck assembly.

In yet another aspect of the present invention, a method of configuring a bikeboard is provided. The method includes the steps of (1) removing a front truck from a deck assembly; (2) with a front bicycle assembly coupled to a frame assembly, placing an upper mounting plate of the frame assembly in contact with a front portion and an upper surface of the deck assembly; (3) placing a lower mounting plate of the frame assembly in contact with the front portion and a lower surface of the deck assembly; and (4) fastening the upper and lower mounting plates to the deck assembly so as to sandwich the front portion of the deck assembly between the mounting plates. The fastening includes inserting fasteners through complementary bolt patterns formed in each of the front portion of the deck assembly, the upper mounting plate, and the lower mounting plate.

### BRIEF DESCRIPTION OF THE DRAWINGS

Preferred and alternative embodiments of the present invention are described in detail below with reference to the following drawings:

FIG. 1A is a side, perspective view of a bikeboard according to an embodiment of the present invention;

FIG. 1B is a bottom, perspective view of the bikeboard of FIG. 1A;

FIG. 2 is perspective view of a modular frame assembly of the bikeboard of FIG. 1A; and

FIG. 3 are perspective views of several different modular frame assemblies for a bikeboard according to other embodiments of the present invention.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated bicycles and skateboards have not necessarily been shown or described in detail to avoid unnecessarily obscuring descriptions of the embodiments of the invention.

The present invention is directed to a rideable and steerable “bikeboard” that combines aspects of bicycling and longboard-style skateboarding. In one embodiment, the bikeboard is a low-profile riding platform connected to a steerable front bicycle assembly with a modular frame. The riding platform may take the form of a longboard-style deck with removable front and rear wheel truck assemblies. The front bicycle assembly includes a large, front wheel, bicycle-style handlebars and a braking system.

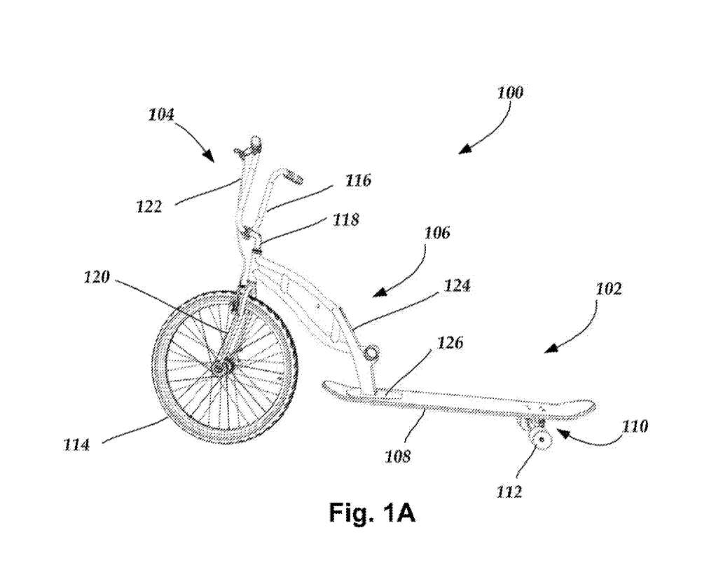

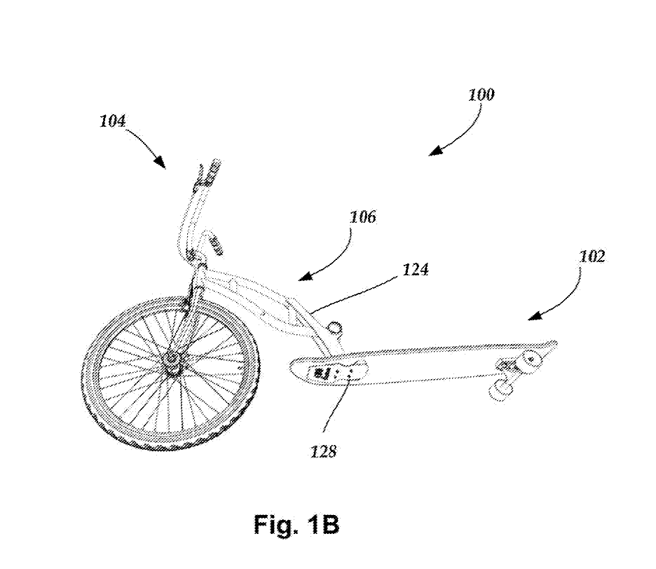

FIGS. 1A and 1B show a bikeboard 100 having a deck assembly 102, a front bicycle assembly 104 and a modular frame assembly 106 according to an embodiment of the present invention. The deck assembly 102 may include a riding platform 108 coupled to a rear truck 110, which in turn is coupled to at least one pair of skateboard-type wheels 112. The board 108, the rear truck 110 and the wheels 112 may take the form of standard, off-the-shelf skateboard or longboard components. As used herein, the term “skateboard” includes any type of riding platform such as, but not limited to, boards, decks, and longboards that may have trucks and wheels.

The front bicycle assembly 104 may include a wheel 114, handlebars 116, a handlebar stem 118 and a pair of forks 120. The front bicycle assembly 104 may also include a brake system 122. The front bicycle assembly 104 may be assembled using standard, off-the-shelf bicycle components and may also include custom components specific to the present bikeboard.

The bikeboard may be obtained as a complete system, a kit, or as separate individual components or sub-assemblies.

The modular frame assembly 106 includes a frame body 124 secured to an upper mounting plate 126. Referring briefly to FIG. 1B, the modular frame assembly 106 also includes a lower mounting plate 128. The mounting plates 126, 128 operate to sandwich the board 108 using mounting holes preferably arranged in a bolt pattern consistent with a standard front skateboard truck as will be explained in more detail below.

In one embodiment, the modular frame assembly 106 is universally attachable to a variety of front bicycle components and a variety of skateboard components to generate many different bikeboard systems. The deck assembly 102, in particular, may be easily and quickly transformed from a skateboard to a bikeboard, and then back again.

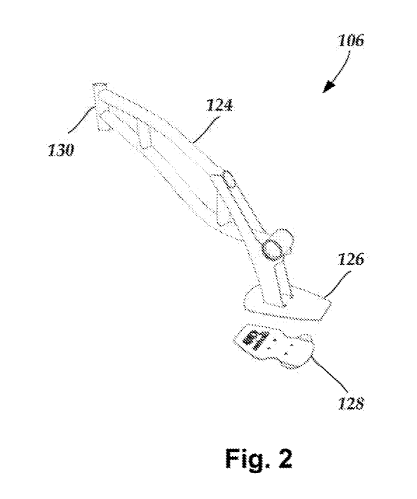

FIG. 2 shows the modular frame assembly 106 having the frame body 124, the upper mounting plate 126 and the lower mounting plate 128. The frame body 124 includes a steering connector 130 (such as a standard steering tube). In the illustrated embodiment, the frame body 124, the upper mounting plate 126 and the steering connector 130 are welded together. However, these components may be produced as a unitary, monolithic structure or may be assembled together using known techniques such as, but not limited to, gluing, stamping, fastening, etc.

The mounting plates 126, 128 each have a matching four-bolt pattern that preferably aligns with a standard, four-bolt skateboard truck pattern. However, it is appreciated that other bolt patterns or attachment means may be utilized to structurally connect the modular frame assembly 106 to the deck assembly 102. The upper mounting plate 126 and the lower mounting plate 128 operate to sandwich the riding platform 108 (FIG. 1A). The plates 126, 128 are sized to distribute the various loads applied to the bikeboard while allowing the riding platform 108 to remain flexible (e.g., bending, torsion, shear) aft of the mounting location. The plates 126, 128 include enlarged surface areas to spread the load that is encountered at the joining location to a larger area of the board so as to decrease the point forces on the board. In this way, the plates avoid breakage of the board, even with heavy and/or aggressive riders and terrain. The fastening location of the frame assembly 106 to the deck assembly 102, being distanced from the front wheel and from the rear wheels, encounters significant bending and torsional forces. The arrangement of the plates clamped on either side of the board and spreading the load with the large size of the plates helps advantageously resolve these forces to be carried by the frame assembly and the deck assembly. The flexibility of the plates can be tailored to progressively distribute the load. Thus, some flex in the plates themselves away from the fastener locations in the plates can also be advantageous.

As noted above, the plates allow the riding platform to remain flexible aft of the mounting location. The torsional flexibility of the riding platform 108 aft of the mounting location may allow the bikeboard to be at least partially steered with the rear truck 110 (FIG. 1A), which is somewhat like steering a skateboard by using a rider's movements and center of gravity to control the skateboard. Likewise, the front bicycle assembly 104 (FIG. 1A) may be steered like a bicycle vis-à-vis the handlebars. Steering can be a combination of front wheel, rear truck, and board flex steering.

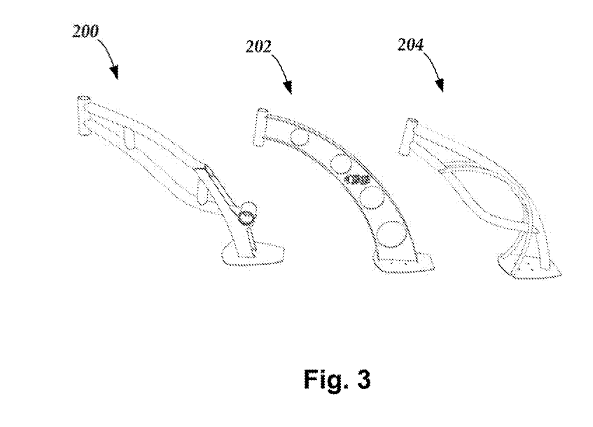

FIG. 3 shows three different modular frame assemblies 200, 202, 204 (lower mounting plate 128 not shown). It is contemplated that the modular frame assembly may take many different shapes and configurations depending on a variety of factors such as, but not limited to, aesthetics, strength, flexibility, cost, the type of front bicycle assembly, and the type of deck assembly.

In operation, the bikeboard may be maneuvered based on the rider's chosen foot placement. By way of example, the bikeboard may be ridden in a sideways stance such as on a snowboard for deep carving, in a side-by-side forward facing manner akin to a slalom position for speed and stability, or with one foot behind the other in a traditional skateboarding style.

With a universal bolt pattern, the deck assembly may be quickly and easily exchanged with a different deck assembly as effortlessly as changing out a skateboard truck. In addition, riders may create customized bikeboards by using different deck assemblies, front bicycle assemblies, modular frame assemblies, and various components or sub-assemblies of the same.

While preferred embodiments of the invention have been illustrated and described, as noted above, many changes can be made without departing from the spirit and scope of the invention. In addition, other advantages will also be apparent to those of skill in the art with respect to any of the above-described embodiments whether viewed individually or in some combination thereof. Accordingly, the scope of the invention is not limited by the disclosure of the preferred embodiment. Instead, the invention should be determined entirely by reference to the claims that follow.

What is claimed as new and desired to be protected by Letters Patent of the United States is:

1. A modular frame assembly for a bikeboard having a front bicycle assembly and a deck assembly, the modular frame assembly comprising:
a frame body having a steering connector configured to be coupled to the front bicycle assembly;
an upper mounting plate coupled to the frame body, the upper mounting plate having an upper plate bolt pattern arranged for attaching to an upper surface of a front portion of the deck assembly, wherein the deck assembly includes a complementary deck bolt pattern; and
a lower mounting plate having a lower plate bolt pattern arranged for attaching to a bottom surface of the deck assembly with the deck bolt pattern, wherein upper and lower mounting plates operate to sandwich a front portion of the deck assembly.

2. The modular frame assembly of claim 1, wherein the frame body and the upper mounting plate are integrally formed as a unitary structure.

3. The modular frame assembly of claim 1, wherein a lower mounting plate profile is complementary to an upper mounting plate profile.

4. The modular frame assembly of claim 1, wherein the deck bolt pattern is a standard, four-bolt skateboard pattern for attaching a front truck.

5. The modular frame assembly of claim 1, wherein the upper and lower mounting plates are sized to permit flexion of the deck assembly aft of the mounting plates.

6. The modular frame assembly of claim 1, wherein the frame body is structurally configured to transfer loads between the front bicycle assembly and the deck assembly.

7. The modular frame assembly of claim 6, wherein the upper and lower mounting plates are sized to distribute loads from the frame body to the deck assembly.

8. A bikeboard comprising:
a front bicycle assembly having a wheel and handlebars;
a deck assembly having a riding platform coupled to a rear truck, which is coupled to wheels;
a frame body having a steering connector configured to be coupled to the front bicycle assembly;
an upper mounting plate coupled to the frame body, the upper mounting plate having an upper plate bolt pattern arranged for attaching to an upper surface of a front portion of the deck assembly, wherein the deck assembly includes a complementary deck bolt pattern; and
a lower mounting plate having a lower plate bolt pattern arranged for attaching to a bottom surface of the deck assembly with the deck bolt pattern, wherein upper and lower mounting plates operate to sandwich the front portion of the deck assembly.

9. The modular frame assembly of claim 8, wherein the frame body and the upper mounting plate are integrally formed as a unitary structure.

10. The modular frame assembly of claim 8, wherein a lower mounting plate profile is complementary to an upper mounting plate profile.

11. The modular frame assembly of claim 8, wherein the deck bolt pattern is a standard, four-bolt skateboard pattern for attaching a front truck to the front portion of the deck assembly.

12. The modular frame assembly of claim 8, wherein the upper and lower mounting plates are sized to permit flexion of the deck assembly aft of the mounting plates.

13. The modular frame assembly of claim 8, wherein the frame body is structurally configured to transfer loads between the front bicycle assembly and the deck assembly.

14. The modular frame assembly of claim 8, further including a braking system coupled to the front bicycle assembly.

15. A method of configuring a bikeboard, the method comprising:
removing a front truck from a deck assembly;
with a front bicycle assembly coupled to a frame assembly, placing an upper mounting plate of the frame assembly in contact with a front portion and an upper surface of the deck assembly;
placing a lower mounting plate of the frame assembly in contact with the front portion and a lower surface of the deck assembly; and
fastening the upper and lower mounting plates to the deck assembly so as to sandwich the front portion of the deck assembly between the mounting plates, wherein the fastening includes inserting fasteners through complementary bolt patterns formed in each of the front portion of the deck assembly, the upper mounting plate and the lower mounting plate.

16. The method of claim 15, further comprising replacing the front bicycle assembly with a different front bicycle assembly.

17. The method of claim 15, further comprising replacing the deck assembly with a different deck assembly.

18. The method of claim 15, further comprising replacing the frame assembly with a different frame assembly.
